(19) United States
(12) Patent Application Publication
(10) Pub. No.: US 2025/0391140 A1
(43) Pub. Date: Dec. 25, 2025

(54) Generating a Three-Dimensional World with Parameter Flows Between Simulation Blocks

(71) Applicant: Playable Worlds, Inc., San Marcos, CA (US)

(72) Inventors: Raphael Koster, San Diego, CA (US); Sean Grady, Port Angeles, WA (US)

(21) Appl. No.: 19/245,073

(22) Filed: Jun. 20, 2025

Related U.S. Application Data
(60) Provisional application No. 63/662,796, filed on Jun. 21, 2024.

(51) Int. Cl. G06T 19/20; G06T 13/20

(52) U.S. Cl. CPC G06T 19/20; G06T 13/20; G06T 2219/2004

(57) ABSTRACT

A virtual world simulation system builds worlds from cells. Each cell is assigned parameters such as resource type, temperature, pressure, density, adhesion, or support, etc. The parameters for a cell are updated using the parameters of surrounding cells. Properties for groups of cells of one or more group sizes can be aggregated to form influence maps at one or more scales. The aggregated properties of feature maps may be used to update properties of cells or objects within the corresponding region of the virtual world.

### CROSS-REFERENCE TO RELATED APPLICATIONS

This Application claims the benefit of U.S. Provisional Patent Application No. 63/662,796, filed Jun. 21, 2024, which is incorporated by reference.

### BACKGROUND

### 1. Technical Field

The subject matter described relates generally to virtual worlds and, in particular, to providing virtual worlds that dynamically update based on interactions between components of the virtual world.

### 2. Background Information

The real world is constantly evolving. Water flow and weather cause erosion and other effects that change the landscape. Fires and other extreme events destroy flora allow for new growth. Ecosystems fluctuate and evolve as conditions change. In contrast, conventional virtual worlds are relatively static, which can negatively impact user immersion over time. Changes to the world need to be hardcoded, which is time and resource intensive. For example, if a virtual environment is designed initially with a summer theme, depicting the same environment in winter requires the creation of numerous new assets. An artist must create updated versions of the plants in the environment (e.g., trees without leaves, bushes covered in snow, etc.), a designer must modify what animals appear in the environment and how they behave, a programmer must modify how objects interact in the environment (e.g., water may be frozen making a river walkable space rather than swimmable space), etc.

These demands typically force world builders to limit changes in their virtual worlds to a small number of narrative-essential changes. They also lead world builders to make abrupt, wholesale changes to the world (e.g., having a winter version and a summer version) rather than the world evolving in a more realistic manner. There is thus a need for tools to enable the building of virtual worlds that dynamically evolve over time.

### SUMMARY

The above and other problems may be solved by a virtual world simulation system in which worlds are built from cells (or voxels). Each cell is assigned parameters such as resource type, temperature, pressure, density, adhesion, or support, etc. The parameters for a cell are updated using the parameters of surrounding cells. For example, a cooler cell next to a warmer cell is heated and vice versa, the resource density of a lower-pressure cell next to a higher-pressure cell increase and vice versa, etc. In some embodiments, properties for groups of cells of one or more group sizes are aggregated to form influence maps at one or more scales. The term properties is used here to mean any combination of resources, parameters (e.g., temperature, pressure, etc.), and physical properties (e.g., densities, melting points, freezing points, etc.). The aggregated properties of feature maps may be used to update properties of cells or objects within the corresponding region of the virtual world. For example, the total amount of water in a region may be aggregated to determine an overall humidity and the appearance of resources and vegetation may be updated to reflect the humidity. It should be appreciated that a wide range of metrics may be calculated by aggregating cell properties and a wide range of properties of the virtual world may be updated using these metrics, depending on the needs of the specific use case.

### BRIEF DESCRIPTION OF THE DRAWINGS

FIG. 1 is a block diagram of a networked computing environment suitable for providing dynamically updating virtual worlds, according to one embodiment.

FIG. 2 is a block diagram of the server of FIG. 1, according to one embodiment.

FIG. 3 is a block diagram of the initiation module, according to one embodiment.

FIG. 4 is a block diagram of the interaction module of the server, according to one embodiment.

FIG. 5 is a block diagram of the update module of the server, according to one embodiment.

FIG. 6 is a flowchart of a method for simulating evolution of the state of a virtual world, according to one embodiment.

FIG. 7 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

In various embodiments, a virtual world is simulated using a cellular automata simulation, or CASim. The CASim is a 3D grid-based simulation, in which cells have quantities of material and other parameters (e.g., temperature, pressure, etc.) that define a cell state for which equations are solved such that the material and parameters “move” from cell to cell. The state of the simulation is used to render a virtual world environment. The result is that many expected effects can be simply generated. For example, where water is moving downwards between cells in the grid, a waterfall can be rendered; where cells including some amount of a stone resource are supporting each other, an arched cave entrance appears; and where fire is present in a cell with grass, burning grass is rendered in the virtual environment, etc.

A list of resource types can be determined from a resource system for the virtual world. The resource system includes a list of resources, such as metal, wood, light, death, and other such tags. These may be arranged in a tree such that tags can be hierarchically arranged by specificity. For example, metal and be divided into ferrous and nonferrous metals, with the former further divided into iron and steel and the latter including other metals such as copper, aluminum, and bronze, etc. Each resource type has physical properties associated with it, such as a flow rate, a boiling point, a freezing point, a density, an adhesion value, a growth rate (a rate at which the amount of the resource spontaneously increments), a death rate (a rate at which the amount of the resource spontaneously decrements, which can prevent resources that are created by sources from flooding the virtual world), a break point (indicating a threshold where adhesion is insufficient to prevent an arch or other unsupported structure from collapsing), a gravity tag (indicating whether gravity affect the resource), etc.

When an agent is updated, a set of rules can be applied to update the simulation state. Interaction rules can determine whether a resource type destroys other resource types in the same or adjacent cells. Transformation rules can result in growth or destruction of the resource (e.g., based on growth or death rates). Transformation rules may also result in resources changing, such as a dirt cell adjacent to a water cell resulting in both cells converting into mud. The amount of the resource in the cell may be updated based on the pressure of adjacent cells (i.e., material can flow from one cell to another along a pressure gradient). The material in the cell may fall downward due to gravity if not supported from underneath or sufficiently adhered to something to one or more of the cell's sides or above the cell. Materials that have changed in temperature may change their state of matter (e.g., from solid to liquid, liquid to gas, or the reverse transitions).

Different states of matter may be treated differently in the simulation. In one embodiment, solids are rendered as a mix of particles and meshes (e.g., depending on the number of contiguous cells including the solid material) and are generally collidable. Liquids may also be rendered as a mixture of particles or using a mesh, depending on the specific situation. Liquids are generally not collidable but objects may float on them and they may have an impact on locomotion (e.g. through viscosity/drag modeling). Gases are typically rendered using a particle approach and the material is not considered collidable.

In one embodiment, solids are meshed into the terrain using a voxel mesher. The texture for a given cell is selected based on one or more properties, including which resource type is assigned to (or makes up the majority of the mass) in the cell, how much water is in the cell, what the surface normal of the resultant mesh is (e.g., so that the top side of dirt can have a different texture than the side of it), what the temperature of the cell is, etc.

Liquids may be rendered using a combination of a heightfield mesh for all cells which are supported by a cell full of fluids, and particles for “suspended liquid” in mid-air. The rendering of bodies of liquid using a heightfield or other mesh can include animated surfaces such that it appears that liquid is flowing downwards, with the animation effect being impacted by the rate of flow (e.g., a slowly moving river will look glassy while a fast-moving river will look like “white water,” etc.). The rate of flow may also be impacted by temperature. For example, as lava increases in temperature if may become less viscous and appear to flow faster (as well as flow faster between cells in the underlying simulation).

Based on the above and the following description, it should be appreciated that a wide range of materials and parameters may be simulated to flow or otherwise transfer between cells. It should further be appreciated that a wide range of physical effects can be produced and rendered using this flow of material and parameters between cells.

### Example Systems

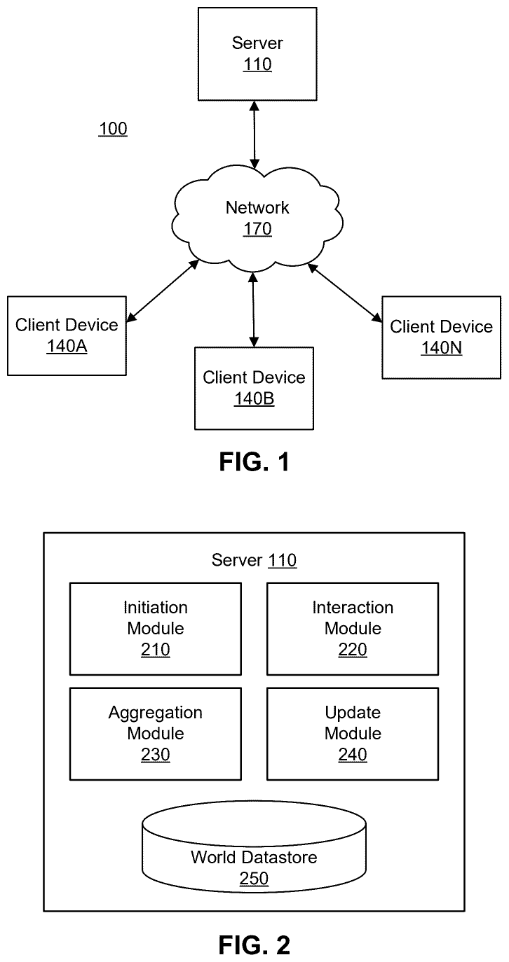

FIG. 1 illustrates one embodiment of a networked computing environment 100 suitable for providing dynamically updating virtual worlds. In the embodiment shown, the networked computing environment 100 includes a server 110 and one or more client devices 140, all connected via a network 170. In other embodiments, the networked computing environment 100 includes different or additional elements. In addition, the functions may be distributed among the elements in a different manner than described.

The server 110 includes one or more computing devices that host one or more virtual worlds that users may interact. Although one server 110 is shown, the networked 110 computing environment 100 may include multiple servers, each hosting different virtual worlds. In the description that follows, the virtual worlds are typically described in the context of a game that is played by users via their client devices 140. However, it should be appreciated that the same or similar techniques may be applied for providing virtual worlds for other purposes.

A virtual world is made up of a set of cells that are initialized with an initial state. In one embodiment, each cell is a cube of fixed proportions (e.g., having sides of one meter). Each cell is assigned a set of properties, such as resource (material), density, and temperature, etc. A cell may be assigned a single resource (which is beneficial for efficient memory usage) or may be assigned a value for the amounts of different resources present in the cell (which requires more memory but can enable more nuanced interactions). Where cells can have amounts of different resources assigned, the cell may be treated as having the resource type of the most prevalent resource or may be given other parameters that are a blend of the different resources present. The cell properties may be generated procedurally, by a human world designer, or by a combination of both (e.g., the world designer may set general requirements that are used to procedurally generate the initial state of the world, which may then be tweaked as desired by the world builder). The world may also be assigned global properties, such distances to one or more suns providing light, the color of light provided by the sun(s), orbit times (providing season lengths), axial tilt (impacting a degree of variation between seasons, and the like.

Once the world has been initialized, the evolution of the state of the world is simulated. In one embodiment, the server 110 maintains lists of cells that have changed or may change to reduce the number of cells that need to be considered during each tick of the simulation. The properties of each cell that is simulated in a tick are compared to the properties of neighboring cells and the properties updated accordingly: heat flows from hotter cells to cooler cells, matter flows from higher pressure cells to lower pressure cells, unsupported solid or liquid material falls under gravity into lower cells, etc. Under certain circumstances, a cell may undergo a phase change. For example, if the temperature of a call increases above a melting or boiling point of the cell's resource, the cell may change from solid to liquid or liquid to gas, respectively. Similarly, if the temperature of a call reduces below a condensation point or freezing point, the cell may change from a gas to a liquid or a liquid to a solid, respectively. As another example, certain resources that are in proximity to each other (e.g., in adjacent cells) may induce a phase change, such as a chemical reaction, that changes the resource type of one or both cells.

In some embodiments, the server 110 also calculates influence maps for regions of the virtual world by calculating aggregate metrics for groups of cells at one or more length scales. The server 110 may use the influence maps to update properties of cells, groups of cells, or objects within the regions corresponding to the influence maps, such as changing the color and texture of surfaces/objects within the virtual world, dynamically changing a biome type assigned to cells based on changing conditions, or modifying the behavior of creatures in the region, etc.

Various embodiments of the server 110 and techniques for providing dynamic updates to virtual worlds are described in greater detail below, with reference to FIGS. 2 through 4.

The client devices 140 are computing devices with which user access the virtual worlds. For example, the client devices may be desktop computers, mobile devices, or dedicated gaming devices, configured to connect to the server 110 via the network 170 and enable the user to interact with a virtual world. Although FIG. 1 shows three client devices 140 (a first client device 140A, a second client device 140B, and an Nth client device 140N), the networked computing environment 100 may include any number of such devices and will typically include many more than three.

In one embodiment, the virtual world is part of a multiplayer game and multiple players may interact with both the virtual world and each other. Each player may login to an account for the game using their client device 140 and be provided access to the virtual world in which they may be depicted by an avatar or other visual representation of the player's current location in the virtual world. If the player takes an action that impacts the state of the virtual world (e.g., lighting a fire), this action may be fed into the simulation performed by the server 110, resulting in dynamic updates to the world state that are experienced by other players. Thus, the changes made to the virtual world can be considered persistent in that other players who visit the same part of the virtual world later will see the impact of the earlier player's actions until some other event within the simulation eradicates the signs of the earlier player's presence.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the server 110. In the embodiment shown, the server 110 includes an initiation module 210, an interaction module 220, an aggregation module 230, an update module 240, and a world datastore 250. In other embodiments, the server 110 includes different or additional elements. In addition, the functions may be distributed among the elements in a different manner than described.

The initiation module 210 initiates virtual worlds. Although the initiation module 210 is shown as part of the server 110, in some embodiments a world may be initiated by a separate system (e.g., a development system) and provided to the server 110 for deployment. In one embodiment, a world is initialized by generating a heightfield map that can then be converted into a voxel map with resources assigned to each cell. The resources may be initially selected probabilistically to achieve a designer-desired distribution. Resources may be categorized hierarchically. For example, a world may have a certain proportion of rock and a certain proportion of soil, with the rock component broken down into different types of rock (e.g., granite, slate, sandstone, etc.) according to selected (or randomly generated) proportions and similarly the soil being broken down into different soil types (e.g., topsoil, loam, clay, etc.).

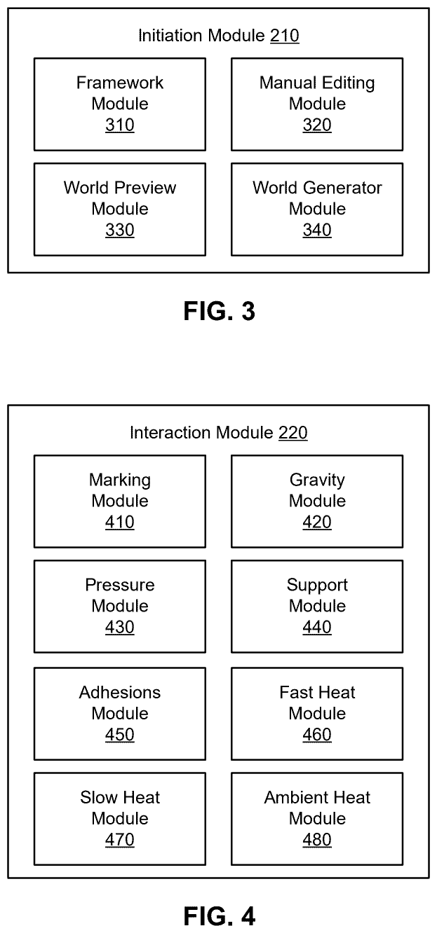

In some embodiments, the initiation module 210 provides a design tool with which a world designer can build a graph for building the heightfield and voxel maps and assigning appropriate resources and preview the results. The nodes of the graph and any relevant parameters may be automatically populated with known “good” choices drawn from previously created manual data. The world designer may then preview the resulting world and make any tweaks they desire until they are happy with the world. Various embodiments of the initiation module 210 are described in greater detail below, with reference to FIG. 3.

Once a world has been initiated, the server 110 makes it available to players to interact with via their client devices 140. The parameters of the world defining its current state may be stored in the world datastore 250, which includes one or more non-transitory computer readable media. As described previously, the world includes a set of cells (or voxels), each having a set of assigned parameters that can be updated with each tick of the simulation. The interaction module 220 determines which cells to update in each simulation tick and updates the parameters of those cells based on the parameters of neighboring cells. The parameters include materials and states of matter for those materials. Different states of matter may be treated differently within the simulation. For example, liquids and gasses may be subject to flow between adjacent cells due to pressure while pressure may be applied to solid to determine whether they break (e.g., turning stone into gravel). Details of various embodiments of the simulation are described in greater detail below, with reference to FIG. 4.

The aggregation module 230 calculates influence maps by aggregating data from groups of cells of one or more sizes. The groups of cells corresponding to an influence map may be referred to as a supercell. In one embodiment, the aggregation module 230 calculates influence maps for chunks (e.g., 16×16×16 cell supercells) and supercells for which the edge size increases by a factor of two each time (e.g., 32×32×32, 64×64×64, 128×128×128, etc.). For larger supercells, one or more of the dimensions (e.g., the height) may exceed the world size and thus be capped (e.g., a supercell may include 1024×1024×world height cells). In some embodiments, the time between recalculation of influence maps depends on the scale of the influence map. Larger influence maps may be recalculated less frequently to reflect the fact that it may take time for information about the game world to propagate larger distances. For example, chunk-scale influence maps may be recalculated every second, while the largest influence maps may be recalculated once an hour.

For each supercell, the aggregation module 230 calculates one or more parameters by aggregating data from the cells included within the supercell. Where a supercell is made up of multiple smaller supercells, some or all of the parameters may be calculated from the parameters of the smaller supercells rather than the underlying cells. Parameters may include various statistical measures of a parameter or object type that may be present in the super cell, such as means, medians, minima, and maxima. In one embodiment, the parameters include one or more of: amounts of one or more resources (which may be divided by state of matter for some resources, such that liquid water is tallied separately from steam and lava is tallied separately from rock, etc.), a number of plants of one or more types, a number of trees of one or more types, a number of buildings of one or more types, a median temperature, a minimum temperature, a maximum temperature, a measure of elevation discontinuity (e.g., a distance between the highest and lowest surface cells in the supercell), a median elevation, a weather condition, an amount of surface area covered in water, a number of recent player deaths, a number of recent AI entity (e.g., creature) deaths, a current number of players in the supercell, a total number of AI entities (or specific types of AI entities) currently within the supercell, an average danger rating, or a maximum danger rating. Some values may be normalized. For example, it may be more helpful to know where a region with the most of a particular resource (e.g., gold) is rather than the precise amount of gold present in that region.

In some embodiments, the aggregation module 230 uses a slow decay process. Specifically, increments in the quantity of a tally may be applied immediately when the change occurs while decrements may reduce the quantity by a set amount each update until the tally reflects the currently true value. For example, if a group of deer enters a supercell, the deer count will immediately increase, but if the deer leave, the count will slowly reduce. Thus, the deer will leave a trail as they move, with more deer in motion leaving stronger trails because the increments in deer counts will jump by larger amounts. For example, if one deer enters the cell, the count updates to one. In the next update, the deer remains in the supercell so the count remains at one. In the next update, three more deer enter the supercell so the count increases to four. In the next update, two of the deer have left, but the fixed amount for decrementing the count is one so the reported count is three (even though only two deer remain in the supercell). In the next update, the other two deer have left, and the count decrements again to two. In the next pair of updates, assuming no new deer enter the supercell, the count reduces to one and then zero.

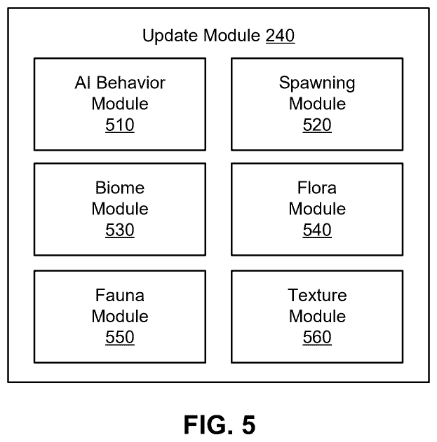

The update module 240 makes updates to the state of the virtual world using the outputs from the interaction module 220, the aggregation module 230, or both. In various embodiments, the update module 240 updates one or more of: the behavior of AI entities (e.g., creatures) in the virtual world, locations of objects in the virtual world (e.g., spawning new instances of certain types of objects, such as creature lairs, based on influence maps), biomes assigned to areas in the virtual world, flora growing in the virtual world, fauna living in the virtual world, or textures applied to cells (e.g., changing a texture applied to a rock cell from wet stone to dry stone as it dries out). Various embodiments of the update module 240 are described in greater detail below, with reference to FIG. 5.

FIG. 3 illustrates one embodiment of the initiation module 210. In the embodiment shown, the initiation module 210 includes a framework module 310, a manual editing module 320, a world preview module 330, and a world generator module 340. In other embodiments, the initiation module 210 includes different or additional elements. In addition, the functions may be distributed among the elements in a different manner than described.

The framework module 310 generates an initial framework for a virtual world. In one embodiment, the framework includes an initial graph of heightfields and voxel maps. The graph is a collection of nodes, structured as a tree. Each node may have a type, such as being a curve, generator, filter, or blend. A curve is one-dimensional (1D) data that may be input into other processes, such as a heightfield generation process. A generator is a routine that generates two-dimensional (2D) or three-dimensional (3D) data, such as one or more heightfields, using a random seed. A filter is a process that is applied to the output of a single previous node to modify the output of that node, outputting a single output. Conversely, a blend takes the output of multiple previous nodes and combined them to generate a single output. The framework module 310 may populate each cell of the framework with appropriate resources.

In general, a framework may include a tree graph of heightfield nodes that lead up to a final heightfield, which is voxelized and tagged with a specific resource. There can be many such graphs resulting in a collection of voxel map nodes. A voxel graph can then be built from the voxel map nodes to generate a final voxel map defining the cells that make up the virtual world and the corresponding resources for each cell.

In addition to the cell data for a virtual world, the framework module 310 may generate one or more of: per-cell temperature data, a number of suns, a color and brightness for each sun, a day length, a number of moons, a year length, an axial tilt, a base temperature, a base temperature range, a gravity level, a number of species, types of species, a sea level, or the like.

The manual editing module 320 provides a user interface via which a designer can modify a framework for a virtual world. The manual editing module 320 can coordinate with the world preview module 330 to enable the designer to see the impact of changes to the virtual world that will result from the framework. In one embodiment, each node in the graph of the framework is represented by a box with connection points on it. The connection points enable the designer to connect nodes using inputs and outputs. Lines can be drawn between nodes to connect outputs to inputs. In some embodiments, the manual editing tool prevents illegal connections (e.g., attempting to provide a voxel map as the input for a heightfield blend) and connections that would cause recursions. The boxes representing nodes may be color coded or otherwise labeled to indicate the type of node they represent. A designer can select a box representing a node to view and edit properties of the corresponding node (e.g., by typing a value or moving a slider, etc.). The world previewing module 330 can provide various visualizations illustrating the resulting changes to the virtual world,

The world generator module 340 can automatically populate a graph of a framework and set the properties of nodes in the graph using known “good choices.” In one embodiment, these known good choices can be extracted from manually created data with some degree of randomness applied. For example, the world generator module may have a list of parameter value ranges (which may be independent or dependent on each other) that are expected to generate interesting, believable, or otherwise good worlds and select values within these ranges randomly. Thus, the world generator module 340 may generate world files for new files on demand without the need for human input.

FIG. 4 illustrates one embodiment of the interaction module 220. In the embodiment, shown, the interaction module 220 includes a marking module 410, a gravity module 420, a pressure module 430, a support module 440, an adhesion module 450, a fast heat module 460, a slow heat module 470, and an ambient heat module 480. In other embodiments, the interaction module 220 includes different or additional elements. In addition, the functions may be distributed among the elements in a different manner than described.

The marking module 410 tracks which cells to simulate based on whether they have changed or may change due to changes in nearby cells. In one embodiment, the marking module 410 maintains a list of “dirty” chunks and “active” chunks. Each chunk includes one or more cells. Generally, chunks are configured to include enough cells that the simulation can efficiently produce coherent and believable interactions while remaining small enough to simulate with the available compute power at the desired frequency (e.g., a chunk may be a 16×16×16 block of cells). A dirty chunk is one in which at least one cell has changed and thus simulation results need to be provided to the relevant client devices 140 and server routines. An active chunk is one for which a border cell in an adjoining chunk has changed so it should be simulated. Each tick, the simulation visits each active chunk and if any cell changes, the chunk is marked active and dirty, and if a border cell changes, the neighboring chunk is marked as active.

The gravity module 420 determines changes in cell parameters due to the force of gravity. In one embodiment, the gravity module 420 attempts to move mass downward if there is open space below it. For example, an amount of mass in a cell may be represented by a value between a minimum value (e.g., 0, meaning empty) and a maximum value (e.g., 255, meaning full). The effect of gravity on liquids may be reduced by adhesion while the effect on solids may be negated by support, adhesion, or both. Gravity may move mass downwards out of a cell until the cell is empty or the cell beneath it is full. As a result of gravity, the amount of material in one or more cells below a cell including unsupported/insufficiently adhered material will increase and the amount of material in the original cell will decrease (potentially to zero).

The pressure module 430 causes mass to flow between cells due to pressure. Generally, mass moves from high pressure to low pressure. The rate of mass flow may be determined from a base flow rate associated with the resource (e.g., water flows faster than oil which flows faster than honey), which may be modified by the cell state. For example, adhesion with surrounding material may slow the flow rate while higher temperatures may increase the flow rate. In one embodiment, the pressure module 430 iterates over resources in order of decreasing density, and each resource ignores the presence of resources that the pressure module 430 has not yet considered in the current tick. This automatically produces expected effects such as buoyancy/sinking. Furthermore, heavier items flow or fall as if lighter items are not there, with the lighter items then getting squeezed out of the way.

The support module 440 calculates whether a cell is directly supported by the bedrock (i.e., the bottom of) the virtual world. In one embodiment, the support module 440 determines whether every cell in a straight line downwards from the current cell includes collidable material and, if so, tags the cell as supported. The material in a supported cell will generally not fall under gravity so this may remove the need to consider adhesion for the supported cell.

The adhesion module 450 calculates adhesion for the cell (where needed). In one embodiment, the adhesion is calculated as a combination of the stickiness of the resource, an adjacent resource, or a stickiness metric for the pair of resources, and the strength of the resource. The adhesion represents how much other resources cling to the current resource and thus can be used to calculate how far unsupported material can extend before collapsing under gravity. Thus, the inclusion of adhesion enables structures to exist that are not possible using cellular automata that consider only neighboring cells. For example, without adhesion, the center of a stone arch will collapse because the material in the center is “unaware” that it is supported by the cells that form the legs of the arch. More generally, the use of adhesion enables dynamic tracking of the support provided by distant cells in large structures, such that changes in one part of a structure can impact another (e.g., if one leg of an arch is damaged, the center may dynamically collapse due to a change in support).

The fast heat module 460 provides a quick calculation of heat flow. In one embodiment, the fast heat module 460 is triggered frequently (e.g., every tick of the simulation) and solves the heat diffusion equation:

$$\frac{\partial u}{\partial t} = α {∇}^{2} u = α ( \frac{{\partial }^{2} u}{\partial {x}^{2}} + \frac{{\partial }^{2} u}{\partial {y}^{2}} + \frac{{\partial }^{2} u}{\partial {z}^{2}} )$$

This equation ensures conservation of heat and is simple, and thus can be calculated quickly enabling it to run every tick. However, in some scenarios, it may not be sufficient. For example, it can get locked into unexpected steady states and it may take too long in game time for heat to equilibrate throughout an environment.

This may be addressed by the slow heat module 470, which triggers less frequently than the fast heat module 460 (e.g., every five ticks of the simulation), to smooth out steady states and spread heat more evenly throughout the environment. In one embodiment, the slow heat module 470 calculates the average temperature of the neighboring cells and if the current cell is hotter than the average, it reduces the temperature of the current cell by a fixed amount (e.g., one heat unit). Conversely, if the current cell is colder than the average, the slow heat module 470 may increase the temperature of the current cell by a fixed amount (e.g., one heat unit).

The interaction module 220 may also use an ambient heat module 480 to further control the distribution of heat in the environment. The ambient heat module 480 is typically triggered even less frequently than the slow heat module 470 (e.g., once every ten ticks). In one embodiment, the ambient heat module 480 compares the temperature of the current cell to an ambient temperature for the virtual world (or a current region of the virtual world). The ambient temperature may be affected by various factors, such as the season and other global properties of the world. If the temperature of the current cell is less than the ambient temperature, it is increased by a fixed amount (e.g., one heat unit) and vice versa.

The combination of various factors used by the interaction module 220 can lead to dynamic emergence of behaviors that go beyond the contributions of individual factors. For example, heat flow can lead to a change in adhesion such that a structure dynamically collapses a certain period of time after a fire is set at its base. As another example, a rock dropping in a pool of water can increase the water level through pressure changes which in turn leads to dirt around the pool turning into mud. It should be appreciated that a wide range of behaviors can arise dynamically through different combinations of interactions. Furthermore, additional types of interactions can be added to the interaction module 220 with the addition of further submodules that define additional interactions, and these additional interactions can combine with the interactions of other parts of the interaction module 220 to create new emergent behaviors.

FIG. 5 illustrates one embodiment of the update module 240. In the embodiment shown, the update module 240 includes an AI behavior module 510, a spawning module 520, a biome module 530, a flora module 540, a fauna module 550, and a texture module 560. In other embodiments, the update module 240 includes different or additional elements. In addition, the functions may be distributed among the elements in a different manner than described.

The AI behavior module 510 impacts the behavior of AI entities in the virtual world. In one embodiment, the AI behavior module 510 compares wants, preferences, or desires of an AI entity with parameters in influence maps and increases the probability of the AI entity moving towards areas of the world that meet those wants, preferences, or desires. For example, a predator that is hungry will move towards supercells with a high concentration of relevant prey, a person or creature that is thirsty will move towards supercells with a high amount of surface water, and a creature will move towards supercells that have a median temperature closer to its preferred temperature than its current location, etc. It should be appreciated that a wide range of entities may move towards certain regions based on the parameters of supercells indicated by the influence maps.

The spawning module 520 may trigger the creation of various objects or entities in the virtual world based on the influence maps. For example, a lair of a particular creature type may spawn if the temperature or illumination levels in a supercell meet certain requirements. As another example, various visual effects (e.g., snow covering, swarms of flies, etc.) may be triggered based on the parameters associated with supercells in the influence maps. Similarly, props such as fallen branches or shed skins may be spawned near trees and snake lairs, respectively. It should be appreciated that a wide range of props may be spawned based on the conditions and objects in the vicinity of a cell.

The biome module 530 determines and updates the biome associated with cells or supercells. A biome is a classification of the ecosystem of the cell or supercell and influences behavior such as the types of flora that appear, the textures applied to surfaces and objects, the growth or death of flora and fauna, and the like. In various embodiments, biome data is generated when a zone is created based on temperature and humidity data, modified by various factors, and assigns a biome description to each surface cell in the voxel map of a zone. This description is then used to look up a matching biome in the database, and that biome data is then used to dictate how flora and fauna are initially populated. Based on the biome, generic fauna, flora, and resources may be substituted with one or more biome-specific variants. Whether a substitution occurs may be probabilistic so that the final distribution includes a mix of two or more biome-specific variants or one or more biome-specific variants and the generic version. In this context, biome-specific means that the variant can be substituted for the corresponding generic version in that biome, and not that the variant is necessarily unique to that biome (it may also be a biome-specific variant for other biomes that are similar to the current biome).

In one such embodiment, biome data is calculated for every surface cell in the final voxel map. The biome of a cell depends on temperature and humidity. The temperature is calculated per cell using the formula:

$$Temp = Base Temp + ( - 0.1 * ( Elevation + Sea Level ) ) + Latitude Adjustment$$

The latitude indicates the distance from the center of the virtual world e.g., the distance from an equator), either north or south. Latitude is associated with a temperature modifier. Sea level may be a parameter of the world that indicates the mean or median sea level in the z direction. The base temperature may be selected randomly from a range (e.g., 5 degrees to 35 degrees Celsius) for the world and may also be adjusted to reflect a current season (or this modification can be incorporated into the latitude adjustment).

The humidity may be calculated on a supercell basis (e.g., with each supercell being 256×256×256 cells). The humidity for these constructs may be calculated as the average of the amount of water in all cells in the supercell. To determine which biome to apply to a cell, the biome module 530 calculates the humidity of the supercell containing the cell, then calculate the cell's temperature, and uses those two values to look up the appropriate biome in a table. This, because the biome applied to a cell depends on temperature and humidity, as the world evolves and changes, the biome of a cell may change, resulting in a gradual change in the flora and fauna that appear in that cell and the textures that are applied to surfaces of that cell. For example, if a player redirects a river, increasing the humidity of the supercell including the cell, it's biome may change in the next biome update.

The flora module 540 can place new flora as well as manage the growth and spread of existing flora based on biome data. In one embodiment, flora is split into trees, bushes, and ground cover. Depending on the biome assigned to a region, each may spawn in different quantities/densities. The probability of different types of flora spawning in a region (as well as textures applied to it) may also be impacted by various factors, such as biome, temperature, humidity, type of surface (e.g., loam may spawn different plants than sand which in turn may spawn different plants than topsoil, etc.), and proximity to already-placed flora (e.g., one plant may tend to clump, growing near other instances of the same plant, while other types may be synergistic and tend to spawn close together, such as ferns growing in the shadow of trees).

The flora module 540 can also govern the spread of floras. In one embodiment, each type of flora has a time to spread base factor that controls how long it takes for that flora to spread (i.e., duplicate). The base rate may be modified by one or more factors, such as an affinity of the flora with the biome, how close the temperature is to an ideal range for the flora, how close the humidity is to an ideal range for the flora, an affinity of the flora with the soil type of the cell, etc. Each type of flora may also have a spread distance which indicates the maximum distance away at which an existing instance can spawn a new instance, and if no available spot to spawn a new instance of the flora is available within that distance, the flora does not spread. Other factors may impact flora growth. For example, young flora (e.g., tree saplings) may be presented from spreading until a specified amount of time has passed and the flora has matured (e.g., the sapling has become an adult tree).

In some embodiments, if the modifiers result in a spread rate below a threshold (e.g., if the spread rate becomes negative) then instead of spreading, the flora begins to die. If the conditions do not change such that the spread rate exceeds the threshold before the amount of time specified by the death rate passes, the flora will die. Thus, if the conditions in a cell change, then the existing flora may die out and be replaced by different types of flora with greater affinity with the new conditions, automatically producing ecological changes as the world evolves. The proximity of flora to death may be tracked with a health metric and the appearance of the flora may be modified as its health decreases (e.g., the texture applied for leaves may cause them to become sparser, browner, and more shriveled as the flora gets closer to death).

When new flora is created by spread, it can begin as young flora with an initial size that is typically small. Similarly, when flora is initially generated for a region, it may be generated with a mix of different ages and sizes. Regardless, in one embodiment, flora is assigned a target height and a growth rate. Each may be subject to some random variation to create diversity. The flora module 540 periodically causes flora that is less than its target size to grow (e.g., by scaling the corresponding graphical objects). At certain height targets, the flora may enter a new life stage (e.g., moving from sapling to adult) and the graphical object used to represent it may change.

Some flora may also produce resources such as fruit, nuts, or berries. These resources may spawn based on parameters such as season, temperature, humidity, and health of the flora. For example, some or all of these metrics may be combined to generate a score indicating how good the conditions are for production and the amount of the resource produced may scale with this score (e.g., a healthy tree with plenty of water may produce a large amount of fruit while one close to death may produce only one piece of fruit or no fruit at all).

The fauna module 550 manages the spawning and spread of animals. When a new region is created, fauna may be procedurally generated for the region by making small variations to existing fauna. For existing animals, the fauna module 550 may modify population distributions (e.g., by spawning new fauna from lairs at rates set by the properties of the supercell including the lair). The fauna module 550 may also cause updates to the appearance of fauna based on local conditions. For example, in winter animals may appear with thicker coats and then shed them as temperatures rise in the summer. As another example, food abundance for an animal may be determined from influence maps and the visual appearance of the animal updated accordingly (e.g., to look thin and malnourished if food that the animal eats is scarce versus healthy and even overweight if food is abundant).

The texture module 560 updates the textures applied to objects and surfaces based on the local conditions (e.g., as indicated by one or more influence maps). In one embodiment, when rendering a surface, the texture module 560 looks up one or more parameters from the relevant influence maps and selects a texture accordingly. For example, in a hot, dry environment, a rock surface may have a texture applied showing cracks with sand in them. Conversely, in a cold, wet environment, the cracks may be filled with snow or ice. Any number of textures may be defined for a resource or object that correspond to one or more parameter ranges (e.g., a two-dimensional array may be defined with a temperature axis and a humidity axis, each divided into four, resulting in sixteen distinct regions, each of which may have its own texture). Further refinement may be provided by modifying properties of the texture (e.g., a color palette) based on specific values of the parameters. For example, as heat increases or humidity decreases (or both), the texture applied to a grass surface may change from vibrant greens to dull browns or yellows to match the expectation of the player. Similarly, other visual properties of a surface texture may be modified based on various parameters. For example, the shininess of a rock surface may increase as the amount of water increases and the color of sand may vary based on the type of rock present or the biome assigned to the cell including the sand.

### Example Method

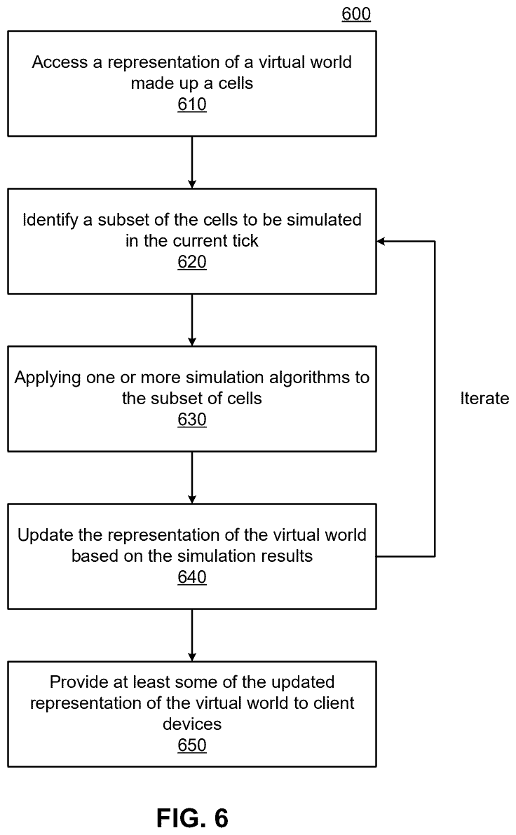

FIG. 6 illustrates one embodiment of a method 600 for simulating evolution of the state of a virtual world. The steps of FIG. 6 are illustrated from the perspective of the server 110 performing the method 600. However, some or all of the steps may be performed by other entities or components. In addition, some embodiments may perform the steps in parallel, perform the steps in different orders, or perform different steps.

In the embodiment shown, the method 600 begins with the server 110 accessing 610 a representation of the virtual world. The representation may be made up of cells with assigned properties, such as resource type, temperature, humidity, density, etc., as described previously. The server 110 identifies 620 a subset of the cells in the representation of the virtual world to be simulated in the current tick. For example, the cells to be simulated may be identified 620 by considering which chunks of the virtual world are dirty and active, as described previously with reference to the marking module 410.

The server 110 applies 620 one or simulation algorithms to the identified cells. For example, the server 110 may step through one or more of the processes described above with reference to the gravity module 420, pressure module 430, support module 440, adhesions module 450, fast heat module 460, slow heat module 470, and ambient heat module 480. The server 110 updates 640 the representation of the virtual world based on the simulation results. The server 110 can provide 650 at least some of the update representation of the virtual world to client devices for those client devices to display views of the virtual world including the updates to the state of the virtual world. For example, each client device may correspond to a user controlling an avatar in the virtual world and the server 110 may provide a portion of the representation of the virtual world to each client device that corresponds to a region of the virtual world surrounding the corresponding user's avatar.

### Computing System Architecture

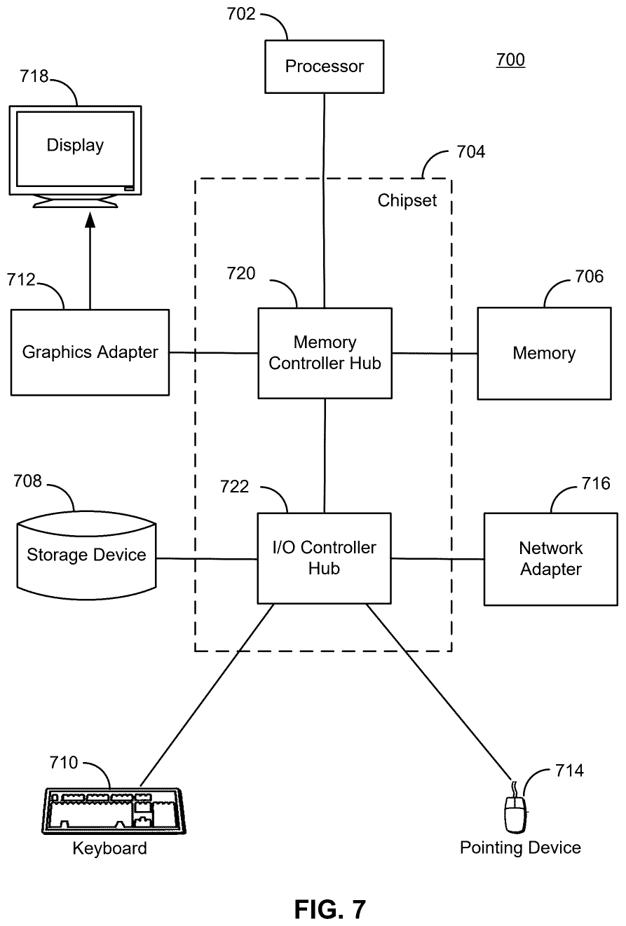

FIG. 7 is a block diagram of an example computer 700 suitable for use as a server 110 or client device 140. The example computer 700 includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, keyboard 710, pointing device 714, and network adapter 716 are coupled to the I/O controller hub 722. Other embodiments of the computer 700 have different architectures.

In the embodiment shown in FIG. 7, the storage device 708 is a non-transitory computer-readable storage medium such as a hard drive, compact disk read-only memory (CD-ROM), DVD, or a solid-state memory device. The memory 706 holds instructions and data used by the processor 702. The pointing device 714 is a mouse, track ball, touchscreen, or other type of pointing device, and may be used in combination with the keyboard 710 (which may be an on-screen keyboard) to input data into the computer system 700. The graphics adapter 712 displays images and other information on the display 718. The network adapter 716 couples the computer system 700 to one or more computer networks, such as network 170.

The types of computers used by the entities of FIGS. 1 through 5 can vary depending upon the embodiment and the processing power required by the entity. For example, the server 110 might include multiple blade servers working together to provide the functionality described while a client device 140 might be a single desktop PC, smartphone, or dedicated gaming device. Furthermore, the computers can lack some of the components described above, such as keyboards 710, graphics adapters 712, and displays 718.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A method of dynamically evolving a state of a virtual world, the method comprising:
accessing a representation of the virtual world, the representation comprising a plurality of cells, each cell having parameters;
performing an iterative simulation, wherein each tick of the iterative simulation comprises:
identifying a subset of the plurality of cells to be simulated in the tick;
applying one or more algorithms to each cell of the subset of the plurality of cells, wherein each of the one or more algorithms updates the parameters of a current cell of the subset of the plurality of cells to which the algorithm is being applied based on the parameters of the current cell and other ones of the plurality of cells that adjoin the current cell; and
updating the representation of the virtual world to reflect the parameters of the subset of the plurality of cells as updated by the one or more algorithms; and
providing at least part of the updated representation of the virtual world to a plurality of client devices for rendering of corresponding views of the virtual world.

2. The method of claim 1, wherein the parameters comprise one or more of a resource type, a temperature, a pressure, a density, an adhesion value, or a support value.

3. The method of claim 1, wherein identifying the subset of the plurality of cells to be simulated in the tick comprises:
accessing a list of active chunks, each chunk including one or more cells of the plurality of cells; and
for each active chunk:
determining whether any cells of the one or more cells of the active chunk have changed for the current tick;
responsive to a cell of the one or more cells having changed, marking the chunk as active and dirty; and
responsive to a border cell that adjoins a neighboring chunk having changed, marking the neighboring chunk as active,
wherein providing the at least part of the updated representation of the virtual world to the plurality of client devices comprises providing updated versions of chunks marked as dirty to the plurality of client devices.

4. The method of claim 1, wherein the one or more algorithms comprise a gravity algorithm, the gravity algorithm moving mass from a first cell to a second cell, disposed below the first cell, responsive to the second cell having space for additional mass, and wherein an amount of mass moved from the first cell to the second cell is reduced by adhesion with adjoining cells, support from cells beneath the first cell, or both.

5. The method of claim 1, wherein the one or more algorithms comprise a pressure algorithm, the pressure algorithm moving mass from a first cell having a first pressure to a second cell, adjacent to the first cell, responsive to the second cell having a second pressure that is lower than the first pressure, and wherein an amount of mass moved from the first cell to the second cell is calculated based on adhesion with adjoining cells, a resource type flow rate, or both.

6. The method of claim 5, wherein the pressure algorithm iterates through resources in order of decreasing density, ignoring resources that the pressure algorithm has not yet visited such that a first resource with a first density flows through a second resource with a second density that is lower than the first density.

7. The method of claim 1, wherein the one or more algorithms comprise a support algorithm, the support algorithm projecting directly downwards from the cell to a bedrock of the virtual world to identify one or more supporting cells that are directly beneath the cell and, responsive to the one or more supporting cells all including collidable material, marking the cell as supported such mass will not move down from the cell.

8. The method of claim 1, wherein the one or more algorithms comprise a fast heat algorithm, the fast heat algorithm running every tick and applying a heat diffusion equation to calculate heat flow to or from the cell from or to adjoining cells.

9. The method of claim 1, wherein the one or more algorithms comprise an adhesion algorithm, the adhesion algorithm calculating an amount of support of material in the cell provided by adhesion with material in adjacent cells, wherein material in the cell moves into a second cell below the cell responsive to the amount of support being less than a force exerted by gravity.

10. The method of claim 1, wherein the one or more algorithms comprise a slow heat algorithm, the slow heat algorithm running on tick numbers that are a multiple of a specified integer, wherein the slow heat algorithm comprises:
determining an average heat of adjoining cells that are adjacent to the cell; and
responsive to a heat of the cell being less than the average heat of the adjoining cells, increasing the heat of the cell by a predetermined amount or, responsive to the heat of the cell being greater than the average heat of the adjoining cells, decreasing the heat of the cell by the predetermined amount.

11. The method of claim 1, wherein the one or more algorithms comprise an ambient heat algorithm, the ambient heat algorithm running on tick numbers that are a multiple of a specified integer, wherein the ambient heat algorithm comprises, responsive to a heat of the cell being less than an ambient heat of the virtual world, increasing the heat of the cell by a predetermined amount or, responsive to the heat of the cell being greater than the ambient heat of the virtual world, decreasing the heat of the cell by the predetermined amount.

12. The method of claim 1, further comprising:
aggregating data from groups of cells to form one or more influence maps storing properties for the groups of cells, the groups having one or more sizes; and
modifying the virtual world based on the influence maps.

13. The method of claim 12, wherein the influence maps include counts of entities in the groups of cells, the counts using a slow decay process such that a first number of a new entities entering the cell increase a corresponding count by the first number while a second number of entities leaving the cell decrease the corresponding count by a third number that is less than the second number.

14. The method of claim 12, wherein modifying the virtual world comprises causing an entity in the virtual world to move towards a region of the virtual world corresponding to a group of cells that the influence maps indicate meet a need, want, or desire of the entity.

15. The method of claim 12, wherein modifying the virtual world comprises spawning an object in the virtual world in a region corresponding to a group of cells that the influence maps indicate meet one or more requirements for spawning of the object.

16. The method of claim 12, wherein modifying the virtual world comprises updating a biome of a region of the virtual world based on temperature and humidity properties of a corresponding group of cells, as indicated by the influence maps.

17. The method of claim 12, wherein modifying the virtual world comprises updating at least one of a spread or appearance of fauna or fauna in the virtual world based on the influence maps.

18. The method of claim 12, wherein modifying the virtual world comprises modifying a texture applied to a surface or object based on the influence maps.

19. A non-transitory computer-readable storage medium storing instructions for evolving a state of a virtual world, the instructions, when executed, causing a computing system to perform operations comprising:
accessing a representation of the virtual world, the representation comprising a plurality of cells, each cell having parameters;
performing an iterative simulation, wherein each tick of the iterative simulation comprises:
identifying a subset of the plurality of cells to be simulated in the tick;
applying one or more algorithms to each cell of the subset of the plurality of cells, wherein each of the one or more algorithms updates the parameters of a current cell of the subset of the plurality of cells to which the algorithm is being applied based on the parameters of the current cell and other ones of the plurality of cells that adjoin the current cell; and
updating the representation of the virtual world to reflect the parameters of the subset of the plurality of cells as updated by the one or more algorithms; and
providing at least part of the updated representation of the virtual world to a plurality of client devices for rendering of corresponding views of the virtual world.

20. A computer system for evolving a state of a virtual world, the computer system comprising:
one or more processors; and
one or more memories storing instructions that, when executed, cause the computing system to perform operations comprising:
accessing a representation of the virtual world, the representation comprising a plurality of cells, each cell having parameters;
performing an iterative simulation, wherein each tick of the iterative simulation comprises:
identifying a subset of the plurality of cells to be simulated in the tick;
applying one or more algorithms to each cell of the subset of the plurality of cells, wherein each of the one or more algorithms updates the parameters of a current cell of the subset of the plurality of cells to which the algorithm is being applied based on the parameters of the current cell and other ones of the plurality of cells that adjoin the current cell; and
updating the representation of the virtual world to reflect the parameters of the subset of the plurality of cells as updated by the one or more algorithms; and
providing at least part of the updated representation of the virtual world to a plurality of client devices for rendering of corresponding views of the virtual world.
